(19) United States
(12) Patent Application Publication
(10) Pub. No.: US 2022/0271359 A1
(43) Pub. Date: Aug. 25, 2022

(54) Traction Battery Having a Degassing Collector, and Motor Vehicle

(71) Applicant: Bayerische Motoren Werke Aktiengesellschaft, Muenchen (DE)

(72) Inventor: Torsten FRANKE, Muenchen (DE)

(21) Appl. No.: 17/668,447

(22) Filed: Feb. 10, 2022

(30) Foreign Application Priority Data
Feb. 12, 2021 (DE) 10 2021 103 378.0

(51) Int. Cl. H01M 10/625; B60L 50/64; H01M 10/613; H01M 50/30

(52) U.S. Cl. CPC H01M 10/625; B60L 50/64; H01M 10/613; H01M 50/30; H01M 2220/20

(57) ABSTRACT

A traction battery for a motor vehicle includes a plurality of battery cells, a battery housing with a plurality of housing walls which surround a receiving space for receiving the battery cells and of which at least one housing wall has a degassing unit for discharging a hot gas from at least one of the battery cells out of the receiving space, and a degassing collector arranged outside the receiving space and having a degassing chamber which can be expanded by the hot gas for receiving the hot gas discharged out of the receiving space. The degassing chamber is delimited by the at least one housing wall and a plate-like, at least partially thermally conductive heat shield.

### CROSS REFERENCE TO RELATED APPLICATION

This application claims priority under 35 U.S.C. § 119 from German Patent Application No. 10 2021 103 378.0, filed Feb. 12, 2021, the entire disclosure of which is herein expressly incorporated by reference.

### BACKGROUND AND SUMMARY OF THE INVENTION

The invention relates to a traction battery for a motor vehicle, having a plurality of battery cells, a battery housing with a plurality of housing walls which surround a receiving space for receiving the battery cells and of which at least one housing wall has a degassing unit for discharging a hot gas from at least one of the battery cells out of the receiving space, and a degassing collector arranged outside the receiving space and having a degassing chamber which can be expanded by the hot gas for receiving the hot gas discharged out of the receiving space. The invention also relates to a motor vehicle.

In the present case, the focus is on traction batteries for electrically driveable motor vehicles, that is to say electric or hybrid vehicles. Such traction batteries usually have a large number of interconnected battery cells which are arranged in a receiving space of a battery housing. The battery cells usually each have a degassing element in order to allow a hot gas produced in a cell housing of the battery cell to escape out of the cell housing into the receiving space in the event of a fault, for example in the case of a short circuit in the cell. This is also referred to as emergency degassing. In addition, the battery housing usually has a degassing unit via which the hot gas collected in the receiving space can escape.

Since heat and substances are transported by the hot gas, it may catch fire upon meeting the ambient air when it exits out of the battery housing. Flames outside the traction battery should be avoided since other vehicle components could catch fire. To this end, DE 10 2014 213 916 A1 proposes equipping the traction battery with a degassing collector which can be deformed by the hot gas in such a way that the volume surrounded by it can be increased in size and via which the hot gas can be discharged. The degassing collector is formed, for example, from a flexible material.

The object of the present invention is to provide a degassing collector for a traction battery of a motor vehicle, which degassing collector is of particularly space-saving design and renders possible safe emergency degassing of the traction battery.

This object is achieved by a traction battery and a motor vehicle having the features according to the claimed invention.

A traction battery according to an embodiment of the invention for a motor vehicle has a plurality of battery cells and a battery housing with a plurality of housing walls which surround a receiving space for receiving the battery cells and of which at least one housing wall has a degassing unit for discharging a hot gas from at least one of the battery cells out of the receiving space. In addition, the traction battery also has a degassing collector arranged outside the receiving space and having a degassing chamber which can be expanded by the hot gas for receiving the hot gas discharged out of the receiving space. The degassing chamber is delimited by the at least one housing wall, having the degassing unit, of the battery housing and a plate-like, at least partially thermally conductive heat shield. The heat shield is designed to cool down the hot gas by distributing heat transported by the hot gas in the degassing chamber. In addition, the heat shield is mounted in a linearly displaceable manner in relation to the housing wall and can be pushed away from the housing wall by the hot gas for expanding the degassing chamber.

The rechargeable traction battery or the traction storage battery can be designed, for example, as a high-voltage energy store. The battery cells can be designed, for example, as prismatic battery cells, round cells or pouch cells. Cell housings of the battery cells can each have a degassing element, for example a bursting membrane, which is designed to allow emergency degassing or damage to a battery cell. In the process, heat and particles or substances are transported out of the cell housing of the damaged battery cell into the receiving space or housing interior of the battery housing by the hot gas.

The battery housing has housing walls which can be designed, for example, as a housing lower part or housing base and a housing top part or housing cover. The battery housing is formed, for example, from steel. The degassing unit, which can likewise have at least one degassing element, for example a bursting membrane and/or a valve, is arranged in at least one of the housing walls. In the event of hot gas collecting in the receiving space after the fault event in at least one battery cell, the hot gas can escape out of the receiving space via the degassing unit in order to prevent other battery cells of the traction battery catching fire. In particular, the degassing unit has a plurality of degassing elements which are arranged in the at least one housing wall. For example, the degassing unit can have one degassing element for each battery cell. The degassing element of the degassing unit can be arranged, for example, in alignment with the respective degassing element of the battery cell, so that the hot gas can be conducted out of the cell housing, via the degassing element of the degassing unit, into the degassing chamber. However, on account of its high temperature, the hot gas is not dissipated directly to the surrounding area, but rather is cooled down beforehand, so that it is possible to prevent the hot gas from catching fire upon meeting the ambient air and therefore flames forming outside the battery housing.

The traction battery has the degassing collector for cooling down in the hot gas discharged out of the receiving space. The degassing collector has a degassing chamber which is arranged outside the receiving space and which has boundaries. A first boundary is formed by the housing wall with the degassing unit and separates the receiving space from the degassing chamber. A second boundary is formed by the heat shield which separates the degassing chamber from the area surrounding the motor vehicle. In this case, the heat shield can be fastened to the housing wall via an unfoldable suspension. The suspension can be formed in one piece with the heat shield here. In this case, the heat shield is, in particular, a rigid, inflexible plate which is arranged so as to overlap with the housing wall having the degassing unit. In this case, a surface area of the heat shield preferably corresponds to at least 90% of a surface area of the housing wall. Therefore, the heat shield overlaps the housing wall for the most part and is arranged, in particular, parallel to the housing wall. Outside the fault event, the heat shield is arranged at a distance from the housing wall, for example adjoining the housing wall. In this case, the lateral suspension is folded and the degassing chamber is unexpanded. Outside the fault event, the degassing collector is therefore of particularly space-saving design. As soon as the fault event occurs and hot gas flows out of the receiving space via the degassing unit, the pressure created by the hot gas pushes the heat shield away from the housing wall, so that the heat shield is arranged at a second distance from the housing wall, the second distance being greater than the first distance. The lateral suspension is unfolded during the pushing away process. Owing to this increase in the distance between the housing wall and the heat shield, the degassing chamber is expanded or increased in size in order to be able to receive the hot gas.

The housing wall having the degassing unit is preferably a housing base which, in an intended installation position of the traction battery in the motor vehicle, faces a roadway for the motor vehicle, where the heat shield can be pushed away downward in the direction of the roadway by the hot gas. In this case, the heat shield can be part of the traction battery, for example part of the battery housing, or can be designed as a vehicle part, for example a vehicle body part, which, for example, additionally serves as an underbody guard or underride guard for the battery housing of the traction battery.

The substances exiting out of the receiving space and transported by the hot gas are therefore guided into the degassing chamber, where the heat shield and/or the battery housing serve as heat stores and cool down the substances exiting out of the receiving space. On account of the heat shield being at least partially, preferably completely, formed from a thermally conductive material, for example aluminum, it is designed to distribute the heat introduced locally into the degassing chamber by the hot gas from a battery cell in the degassing chamber and to cool down the hot gas relatively rapidly in this way. Owing to the distribution of the heat over the volume of the degassing chamber, local overheating at the degassing collector can advantageously be prevented and the temperature of substances output into the area surrounding the traction battery can be limited. In this case, it may be provided that other motor vehicle body elements form boundaries of the degassing chamber, so that the degassing chamber and therefore the cooling path for cooling down the hot gas through the other vehicle body elements are increased in size.

In a development of the invention, a heat-resistant thermal insulation, in particular mica and/or ceramic paper, is arranged in the degassing chamber. For improved protection against local overheating, the boundaries of the degassing chamber can be at least partially provided with the heat-resistant thermal insulation.

As an alternative or in addition, a material expanded by the heat of the hot gas, in particular a heat protection coating, is arranged in the degassing chamber. This expanding material can separate off regions of the degassing chamber that tend to overheat and therefore guide the substances exiting out of the receiving space into regions of the degassing chamber which can still absorb heat.

In an advantageous embodiment of the invention, a flame retardant, in particular magnesium hydroxide and/or aluminum hydroxide, is arranged in the degassing chamber. As an alternative or in addition to the thermal insulation, the flame retardant can be arranged at the boundaries of the receiving space, for example also at the degassing elements of the degassing unit. The flame retardant exhibits an endothermic reaction under the action of heat, as a result of which the maximum thermal load on adjacent components of the motor vehicle is limited.

In a further advantageous embodiment, at least one boundary of the degassing chamber has an outlet for reducing pressure by discharging hot gas out of the degassing chamber into an area surrounding the traction battery. The outlet can be closed, for example, in the non-expanded state of the degassing chamber and can be cleared by expanding the degassing chamber. For example, the heat shield and/or the suspension can have the outlet which is designed, for example, as at least one opening in the heat shield. A material expanded by the heat from the hot gas is particularly preferably arranged in the degassing chamber and is designed to at least temporarily close the outlet in the expanded state for preventing heat exiting to the surrounding area. The material can close the outlet, for example, only for a predetermined period, for example for as long as the hot gas exceeds a temperature threshold, and clear the outlet again after this period. The period can be adjusted, for example, by way of the quantity of expanding material. In particular, the outlet is opened for a predetermined time period during expansion of the degassing chamber and closed by the expanding material after the time period.

Therefore, the outlet is open when hot gas is initially introduced into the degassing chamber in order to prevent a first pressure surge when the degassing unit is opened. Owing to the outlet being closed by way of the expanding material in a controlled manner in the event of overheating, the temperature of substances exiting to the surrounding area can be reduced. It has proven advantageous when the flame retardant or the endothermic material is combined with the expanding material, where the flame retardant is designed to delay the expansion of the expanding material for the purpose of keeping the outlet open over the predetermined time period. The flame retardant therefore ensures that the outlet remains open for the predetermined time period in order to reduce the first pressure surge.

The invention also includes a motor vehicle having at least one traction battery according to an embodiment of the invention. The motor vehicle is an electrically driveable motor vehicle, with the traction battery being arranged in the region of an underbody of the motor vehicle and the heat shield facing a roadway of the motor vehicle.

The embodiments presented with reference to the traction battery according to the invention and the advantages of the embodiments accordingly apply to the motor vehicle according to the invention.

Further features of the invention can be gathered from the claims, the figures and the description of the figures. The features and combinations of features mentioned above in the description and the features and combinations of features mentioned below in the description of the figures and/or shown in the figures alone can be used not only in the respectively indicated combination but also in other combinations or on their own.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a first embodiment of a traction battery.

FIG. 2 shows a schematic illustration of a second embodiment of a traction battery.

### DETAILED DESCRIPTION OF THE DRAWINGS

In the figures, identical or functionally identical elements are provided with the same reference signs.

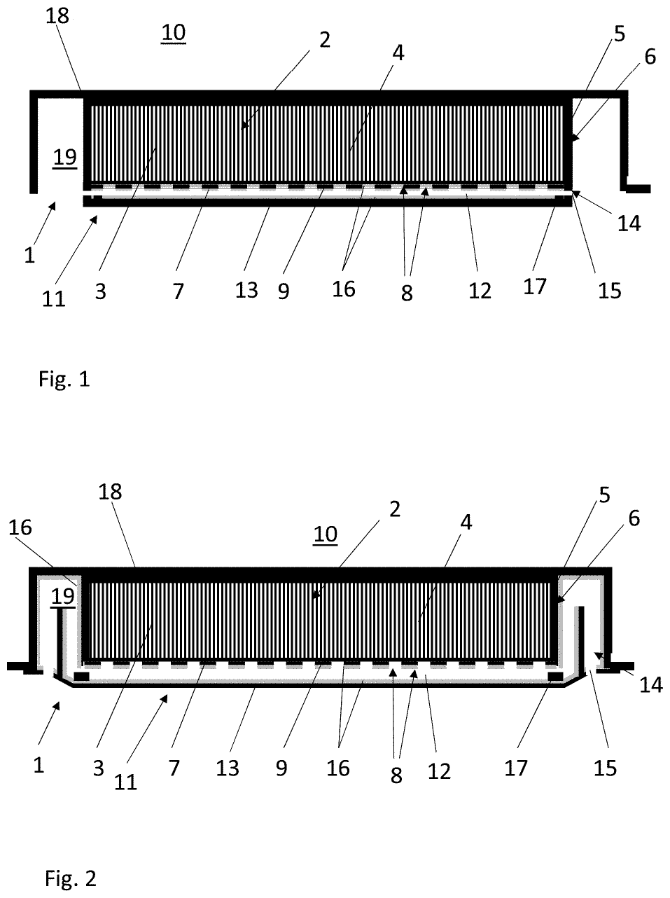

FIG. 1 and FIG. 2 show embodiments of a traction battery 1 for an electrically driveable motor vehicle. The traction battery 1 has a cell assembly 2 with a large number of battery cells 3 which can be designed, for example, as round cells. The cell assembly 2 is arranged in a receiving space 4 of a battery housing 5 of the traction battery 1. The battery housing 5 has a plurality of housing walls 6 which delimit the receiving space 4. One of the housing walls 6, here a housing base 7, has a degassing unit 8 which, here, has a large number of degassing elements 9. Here, a degassing element 9, which can be designed as a bursting element for example, is assigned to each battery cell 3. For forming the bursting elements, the housing base has a large number of openings which are covered by a bursting membrane. In the event of a fault, when at least one of the battery cells 3 discharges a hot gas, the bursting membrane tears and the hot gas can escape out of the receiving space 4 via the cleared opening.

In order to prevent introduction of heat caused by hot gas into an area 10 surrounding the traction battery 1, the traction battery 1 has a degassing collector 11 which is designed to receive the hot gas released out of the receiving space 4 via the degassing unit 8 in a degassing chamber 12 and to cool down the hot gas there. The degassing chamber 12 is delimited by the housing base 7 and the heat shield 13. In this case, the heat shield 13 can be pushed away from the housing base 7 downward owing to a pressure that is applied to the heat shield 13 by the hot gas, so that the size of the degassing chamber 12 is increased by the hot gas.

The heat shield 13 is formed from a thermally conductive material, for example aluminum, and is designed to distribute the heat transported by the hot gas into the degassing chamber 12 over the entire surface area of the degassing chamber 12. In an advantageous embodiment, the mechanical design of the housing walls 6 of the battery housing 5 and that of the heat shield 13 are such that they jointly absorb the forces acting on the battery housing 5.

The heat shield 13 also has an outlet 14 with openings 15 which allow gas exchange between the degassing chamber 12 and the surrounding area 10. The housing wall 6 directed toward the degassing chamber 12, here the housing base 7, of the traction battery 1 including the degassing elements 9 and the heat shield 13 are provided with a thermal insulation 16 for preventing local overheating. In a particularly advantageous embodiment, the thermal insulation 16 contains a material that reacts endothermically when heated, that is to say a flame retardant, and is designed in such a way that opening of the degassing elements 9 in the case of a thermal event and associated discharge of hot gas from the associated battery cells 3 are ensured.

A material 17 that expands under the action of heat and closes the openings 15 under an excessive action of heat and prevents a hot gas stream exiting into the surrounding area 10 is applied at a sufficient distance from the openings 15. In an advantageous embodiment, the quantity of material 17 that expands under the action of heat is such that the closure formed yields in a controlled manner under excess pressure and causes a controlled reduction in pressure.

In this case, the traction battery 1 is arranged on a vehicle part 18, for example on a vehicle body part, of the motor vehicle. In this case, intermediate spaces 19, which are formed between regions of the vehicle part 18 and the traction battery 1, can also be used for cooling down the hot gas. For this purpose, a cooling-down path is formed by the degassing chamber 12 and the intermediate spaces 19. In this way, a movement of particles transported by the hot gas is advantageously extended. Therefore, the effect of the heat shield 13 can be further improved. In addition, as shown in FIG. 2, the regions of the vehicle part 18 adjoining the intermediate spaces 19 can be provided with the thermal insulation 16. According to the exemplary embodiment in FIG. 2, the heat shield 13 additionally performs the function of an underride guard 20 for the traction battery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A traction battery for a motor vehicle, the traction battery comprising:
a plurality of battery cells,
a battery housing comprising a plurality of housing walls which surround a receiving space for receiving the battery cells, wherein at least one housing wall of the plurality of housing walls comprises a degassing unit for discharging a hot gas from at least one battery cell of the plurality of battery cells out of the receiving space, and
a degassing collector arranged outside the receiving space and comprising a degassing chamber which is expandable by the hot gas for receiving the hot gas discharged out of the receiving space,
wherein the degassing chamber is delimited by the at least one housing wall comprising the degassing unit and a plate-like, at least partially thermally conductive heat shield, and
wherein the heat shield is mounted in a linearly displaceable manner in relation to the housing wall, is pushable away from the housing wall by the hot gas for expanding the degassing chamber, and is configured to cool down the hot gas by distributing heat transported by the hot gas in the degassing chamber.

2. The traction battery according to claim 1,
wherein the at least one housing wall comprising the degassing unit is a housing base which, in an intended installation position of the traction battery in the motor vehicle, faces a roadway for the motor vehicle, and
wherein the heat shield is pushable away downward in a direction of the roadway by the hot gas.

3. The traction battery according to claim 1,
wherein the heat shield is at least partially formed from aluminum.

4. The traction battery according to claim 1,
wherein a heat-resistant thermal insulation is arranged in the degassing chamber.

5. The traction battery according to claim 4,
wherein the heat-resistant thermal insulation comprises at least one of mica or ceramic paper.

6. The traction battery according to claim 1,
wherein a material expanded by the heat of the hot gas is arranged in the degassing chamber.

7. The traction battery according to claim 6,
wherein the material is a heat protection coating.

8. The traction battery according to claim 1,
wherein a flame retardant is arranged in the degassing chamber.

9. The traction battery according to claim 8,
wherein the flame retardant is at least one of magnesium hydroxide or aluminum hydroxide.

10. The traction battery according to claim 1,
wherein at least one boundary of the degassing chamber has an outlet for reducing pressure by discharging hot gas out of the degassing chamber into an area surrounding the traction battery.

11. The traction battery according to claim 10,
wherein a material expanded by the heat of the hot gas is arranged in the degassing chamber and is configured to at least temporarily close the outlet in an expanded state for preventing heat from exiting to the surrounding area.

12. The traction battery according to claim 11,
wherein the outlet is opened for a predetermined time period during expansion of the degassing chamber and is closable by the expanding material after the time period.

13. A motor vehicle comprising the traction battery according to claim 1.
